(19) United States
(12) Patent Application Publication
(10) Pub. No.: US 2010/0137467 A1
(43) Pub. Date: Jun. 3, 2010

(54) POLYURETHANE FOAM CONTAINING FLAME-RETARDANT MIXTURE

(76) Inventors: Jeffrey K. Stowell, Wingdale, NY (US); Sergei Levchik, Croton-on-Hudson, NY (US); Andrew Piotrowski, Yorktown, NY (US); Weihong Liu, Dobbs Ferry, NY (US); Yinzhong Guo, Brooklyn, NY (US)

Correspondence Address: DILWORTH & BARRESE, LLP, 1000 WOODBURY ROAD, SUITE 405, WOODBURY, NY, 11797, US

(21) Appl. No.: 12/312,594

(22) PCT Filed: Nov. 19, 2007
(86) PCT No.: PCT/US2007/024203

§ 371 Date: Jan. 14, 2010

Related U.S. Application Data
(60) Provisional application No. 60/860,039, filed on Nov. 20, 2006.

(51) Int. Cl. C08J 9/00

(52) U.S. Cl. 521/155

(57) ABSTRACT

The invention relates to flame retarded polyurethane foam containing, inter alia, an effective flame retarding amount of a non-halogen flame-retardant mixture wherein said foam is capable of meeting or exceeding stringent flame retardancy criteria.

### FIELD OF THE INVENTION

The present invention relates to flame-retardant additives for incorporation in polyurethane foam. More particularly, the invention relates to a mixture of cyclic phosphate ester and melamine compound(s) and the use of such mixture as a flame-retardant additive for polyurethane foams.

### BACKGROUND OF THE INVENTION

Flame-retardant additives are often used to reduce the risk and severity of polyurethane foam combustion. A wide variety of flame retardants are known and commercially available for this purpose. However, there are often considerable technical problems and toxicological concerns restricting the use of these flame retardants.

Flexible polyurethane foams are widely used as cushioning or padding materials, for example, in furniture and in automobiles. Flame retardants are generally incorporated into such foams. However, it is difficult to identify flame retardants which will achieve adequate flame retardancy economically without impacting negatively on the physical properties of polyurethane foams and which are environmentally friendly.

Flame-retardant additives commonly used to make flame retarded polyurethane foams typically contain halogen compounds. However, for reasons of product sustainability there is a movement within the industry towards the use of non halogen-containing flame retardants.

Additionally, in order to be commercially acceptable, flame-retarded polyurethane foams must pass certain flame retardancy tests depending upon the application of the foam. While some tests are less stringent than others, it is desirable that the flame-retarded foam pass the more stringent tests, as well as the less stringent, and therefore be useful for all applications. For example, the stringent British Standard BS-5852, Part II, Source V test sets rigorous flame-retardancy standards for foam used in upholstered furniture. Thus, it would be advantageous to provide a flame-retarded polyurethane foam which is not only capable of passing less stringent standard tests, but is capable of passing more stringent tests, such as the aforementioned British Standard test and therefore have more versatility.

The use of phosphate flame-retardants alone, as well as in combination with other flame-retardant additives is known. For example, U.S. Pat. No. 5,750,601 discloses flame retardant polymeric compositions, such as polyurethane foam, containing halogen-free cyclic phosphoric acid esters, e.g., phenyl and alkyl substituted phenyl neopentyl phosphate ester flameproofing agents. U.S. Pat. No. 6,734,239 discloses resins, e.g., polyurethane foams, containing alkyl neopentyl phosphate ester which can be used with other additives, such as, melamine as flame retardants. U.S. Pat. No. 7,045,214 describes recycled resin molded articles made of polycarbonate with additive flame retardants which may include phosphorus-based flame retardants, e.g., phenyl neopentyl phosphate and nitrogen-based flame retardants, such as, melamine.

The desire, however, for polyurethane foam products containing flame retardants which are environmentally friendly and economical and at the same time are capable of meeting or exceeding the most stringent flame retardancy standards still remains.

### SUMMARY OF THE INVENTION

The present invention relates to a flame-retarded polyurethane foam comprising:

a) a polyurethane foam; and

b) an effective flame retarding amount of a flame-retardant mixture comprising:
i) at least one non halogen-containing cyclic phosphate ester having the general formula:

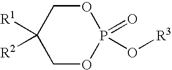

wherein, R¹ and R², are the same or different 1 to 6 carbon atom(s) straight-chain or branched alkyl groups, which may or may not contain heteroatom substituents, and R³ is phenyl or substituted phenyl containing from 6 to 12 carbon atoms, which may or may not contain heteroatom substituents; and
ii) at least one non halogen-containing melamine compound.

### DETAILED DESCRIPTION OF THE INVENTION

In accordance with the present invention, it has unexpectedly been found that a non halogen-containing mixture of an effective flame-retardant amount of a cyclic phenyl phosphate ester and a melamine compound incorporated into a polyurethane foam results in flame retarded foam capable of meeting a variety of flame retardancy standards, e.g., the California Technical Bulletin 117 test criteria, the Motor Vehicle Safety Standard 302 (MVSS 302) test criteria, and the stringent British Standard 5852 (BS 5852) test criteria. In furtherance of the present invention, it has been found that certain neopentyl phenyl phosphate esters and melamine compounds, as more fully described herein below, when added to polyurethane foam provide synergistic flame-retardant results and provides polyurethane foam which meet and/or exceed various flame-retardant test criteria.

The cyclic phosphorus esters of the invention are compounds that contain a phosphorinane ring structure and are useful as flame retardants in compositions, e.g., polyurethanes.

In particular, the cyclic phosphate esters of the present invention are represented by the general formula:

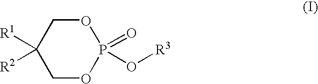

In formula (I), R¹ and R², may be the same or different 1 to 6 carbon atom(s) straight-chain or branched alkyl groups, which may or may not contain heteroatom substituents, e.g., O, N, S, and the like. Examples of R¹ and R² include straight-chain alkyl groups such as methyl, ethyl, n-propyl, n-butyl, n-pentyl, n-hexyl, etc., and branched alkyl groups such as iso-propyl, iso-butyl, sec-butyl, tert-butyl, iso-pentyl, tert-pentyl, neo-pentyl, iso-hexyl, and the like. Among these groups, straight-chain or branched alkyl groups having 1 to 4 carbon atoms are preferred, while methyl is the most preferred.

In formula (I), R³ is a phenyl or substituted phenyl containing from 6 to 12 carbon atoms, which may or may not contain additional heteroatom substituents, e.g., O, N, S, and the like.

The cyclic phosphate esters (I) of the present invention may contain impurities derived from by-products and unreacted materials during production, but may be used as flame retardants without being further purified so long as the impurities do not affect the flame retardancy of polyurethane compositions.

The flame-retardant mixture of the present invention can include one or more species of cyclic phosphate esters (I) and one or more melamine compounds.

In one specific embodiment of the invention, the flame-retardant mixture is a blend of melamine compound and cyclic neopentyl aryl phosphate having the formula:

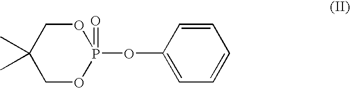

The expression “melamine compound(s)” as used herein includes melamine per se, i.e., the compound 2,4,6-triamino s-triazine, and its flame retardant-effective derivatives. Melamine and its derivatives are those compounds having at least one 6-membered triazine ring or moiety therein in which at least one amino nitrogen atom is directly bonded to at least one such triazine ring on a carbon atom of the ring. When the melamine compound contains more than one such ring or moiety, the rings or moieties can be in the form of fused ring structures (as in melem or melon) or unfused ring structures (as in melam).

For purposes of this invention, melamine is the preferred compound, i.e., 2,4,6-triamino s-triazine. Other melamine compounds useful in the practice of the present invention include derivatives of melamine of the general formula:

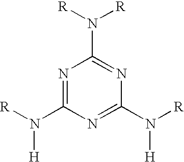

where each R is, independently, a hydrogen atom, a C₁₋₆ alkyl group, a C₅₋₆ cycloalkyl group, a C₆₋₁₂ aryl group, and C₇₋₁₂ aralkyl group. A few non-limiting examples of this type of melamine compounds include melamine, N-methylmelamine, N-cyclohexylmelamine, N-phenylmelamine, N,N-dimethylmelamine, N,N-diethylmelamine, N,N-dipropylmelamine, N,N′-dimethylmelamine, N,N′,N″-trimethylmelamine, and the like. Also alcohol derivatives of melamine such as trimethylolmelamine or triethylolmelamine may be used. Melamine sulfate and melamine phosphates such as melamine orthophosphate, melamine polyphosphate, and dimelamine orthophosphate may also be used. Another useful melamine derivative is melammonium pentate (i.e., the dimelamine salt of pentaerythritol diphosphate). Still other melamine compounds that can be used are melam, melem, and melon. Yet other useful melamine compounds include melamine pyrophosphate and melamine cyanurate, each of which is available commercially. Melamine can be used singly or in a mixture with one or more other melamine compounds, provided the mixture is effective as a flame retardant. Likewise melamine derivatives may be used singly or as mixtures of two or more melamine derivatives, provided the mixture is effective as a flame retardant. Methods for the preparation of melamine compounds are known and reported in the literature. See for example U.S. Pat. No. 4,298,518; Kirk-Othmer Encyclopedia of Chemical Technology, Fourth Edition, volume 7, pages 748-752; Id., volume 10, page 980; and E. Prill, J. Am. Chem. Soc., 1947, 69, 62.

The flame-retardant mixture of the present invention comprises at least one non halogen-containing cyclic phosphate ester and at least one non halogen-containing melamine compound. The ratio of cyclic phosphate ester(s) to melamine compound(s) can vary, and can range from about 1:10 to about 10:1, respectively, and preferably from about 1:5 to about 5:1, respectively, and most preferably from about 1:3 to about 3:1, respectively.

According to one embodiment of the invention, the polyurethane foam comprises cyclic phosphate ester(s) in the amount ranging from about 1 to about 20 weight percent of the total weight of the polyurethane foam, and in another embodiment from about 3 to about 18 weight percent of the total weight of the polyurethane foam. In yet another embodiment of the invention, the polyurethane foam comprises cyclic phosphate ester(s) in the amount ranging from about 5 to about 15 weight percent of the total weight of the polyurethane foam.

According to an embodiment of the invention, the polyurethane foam comprises melamine compound(s) in the amount ranging from about 1 to about 20 weight percent of the total weight of the polyurethane foam, and in another embodiment from about 2 to about 18 weight percent of the total weight of the polyurethane foam. In yet another embodiment of the invention, the polyurethane foam comprises melamine compound(s) in the amount ranging from about 2 to about 15 weight percent of the total weight of the polyurethane foam.

In addition to the mixture of flame retardant compounds of the present invention, additional flame retardant compounds can be incorporated into the polyurethane foam of the invention. Additional flame retardant compounds include, but are not limited to, phosphorus-based flame retardants, some non-limiting examples are triethyl phosphate, ethyl diphenyl phosphate, dibutyl phenyl phosphate, butyl diphenyl phosphate, 2-ethylhexyl diphenyl phosphate, triphenyl phosphate, tricresyl phosphate, alkylated triaryl phosphates, such as butylated or isopropylated triphenyl phosphate, dimethyl methylphosphonate, dimethyl propylphosphonate and the like and mixtures thereof. Although the present invention provides for a non-halogen flame retardant mixture, it is understood that the incorporation of halogen-substituted products can also be used, e.g., tris(chloropropyl) phosphate and tris(dichloroisopropyl) phosphate, N-trifluoromethylmelamine, N-(2-chloroethyl)melamine, N-(3-bromophenyl)melamine and the like and mixtures thereof.

Polyurethane foam compositions are well known in the art. Simply stated, polyurethane foam is obtained by condensation reaction of a diisocyanate with a polyol. The polyols employed in the production of polyurethane foams contain reactive hydrogen atoms. The polyols are hydroxy-functional chemicals or polymers covering a wide range of compositions of varying molecular weights and hydroxy functionality. These polyhydroxyl compounds are generally mixtures of several components although pure polyhydroxyl compounds, i.e. individual compounds, may in principle be used.

The present invention is directed to polyurethane foam produced from polyurethane foam composition comprising polyol which is defined herein to be a normally liquid polymer possessing hydroxyl groups. Further, the polyol can be at least one of the type generally used to prepare polyurethane foams, e.g., a polyether polyol having a molecular weight of from about 18 to about 10,000. The term “polyol” includes linear and branched polyethers (having ether linkages), polyesters and blends thereof, and comprising at least two hydroxyl groups.

Suitable polyols include polyether polyol, polyester polyol, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, and polycarbonate polyols, polyoxypropylene polyether polyol, mixed poly (oxyethylene/oxypropylene) polyether polyol, polybutadienediols, polyoxyalkylene diols, polyoxyalkylene triols, polytetramethylene glycols, polycaprolactone diols and triols, and the like, all of which possess at least two primary hydroxyl groups. In one embodiment, some specific examples of polyether polyol are polyoxyalkylene polyol, particularly linear and branched poly (oxyethylene) glycol, poly (oxypropylene) glycol, copolymers of the same and combinations thereof. Graft or modified polyether polyols, typically called polymer polyols, are those polyether polyols having at least one polymer of ethylenically unsaturated monomers dispersed therein. Non-limiting representative modified polyether polyols include polyoxypropylene polyether polyol into which is dispersed poly (styrene acrylonitrile) or polyurea, and poly (oxyethylene/oxypropylene) polyether polyols into which is dispersed poly (styrene acrylonitrile) or polyurea. Graft or modified polyether polyols comprise dispersed polymeric solids. Suitable polyesters of the present invention, include but are not limited to aromatic polyester polyols such as those made with pthallic anhydride (PA), dimethlyterapthalate (DMT) polyethyleneterapthalate (PET) and aliphatic polyesters, and the like.

The polyol can have a functionality of from about 2 to about 12, and preferably the polyol has a functionality of at least 2.

In one embodiment of the present invention, polyurethane foam composition comprises polyether polyol having a hydroxyl number of from about 10 to about 4000. In another embodiment of the present invention, polyether polyol has a hydroxyl number of from about 20 to about 2,000. In yet another embodiment polyether polyol has a hydroxyl number of from about 30 to about 1,000. In still another embodiment polyether polyol has a hydroxyl number of from about 35 to about 800.

Polyisocyanate of the present invention, include any diisocyanate that is commercially or conventionally used for production of polyurethane foam. In one embodiment of the present invention, the polyisocyanate can be organic compound that comprises at least two isocyanate groups and generally will be any of the known aromatic or aliphatic diisocyanates.

The polyisocyanates that are useful in the polyurethane foam-forming composition of this invention are organic polyisocyanate compounds that contain at least two isocyanate groups and generally will be any of the known aromatic or aliphatic polyisocyanates. According to one embodiment of the present invention, the polyisocyanate can be a hydrocarbon diisocyanate, (e.g. alkylenediisocyanate and arylene diisocyanate), such as toluene diisocyanate, diphenylmethane isocyanate, including polymeric versions, and combinations thereof. In yet another embodiment of the invention, the polyisocyanate can be isomers of the above, such as methylene diphenyl diisocyanate (MDI) and 2,4- and 2,6-toluene diisocyanate (TDI), as well as known triisocyanates and polymethylene poly(phenylene isocyanates) also known as polymeric or crude MDI and combinations thereof. Non-limiting examples of isomers of 2,4- and 2,6-toluene diisocyanate include Mondur® TDI, Papi 27 MDI and combinations thereof.

In one embodiment of the invention, the polyisocyanate can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture.

The amount of polyisocyanate included in polyurethane foam composition relative to the amount of other materials in polyurethane foam composition is described in terms of “Isocyanate Index.” “Isocyanate Index” means the actual amount of polyisocyanate used divided by the theoretically required stoichiometric amount of polyisocyanate required to react with all active hydrogen in polyurethane foam-forming composition multiplied by one hundred (100). In one embodiment of the present invention, the Isocyanate Index in the polyurethane foam-forming composition used in the process herein is of from about 60 to about 300, and in another embodiment, of from about 70 to about 200 and in yet another embodiment, of from about 80 to about 120.

Catalysts for the production of the polyurethane foams are known in the art and can be a single catalyst or mixture of catalysts such as those commonly used to catalyze the reactions of polyol and water with polyisocyanates to form polyurethane foam. It is common, but not required, to use both an organoamine and an organotin compound for this purpose. Other metal catalysts can be used in place of, or in addition to, organotin compound. Suitable non-limiting examples of polyurethane foam-forming catalysts include (i) tertiary amines, (ii) strong bases such as alkali and alkaline earth metal hydroxides, (iii) acidic metal salts of strong acids, (iv) chelates of various metals, (v) alcoholates and phenolates of various metals, (vi) salts of organic acids, (vii) organometallic derivatives of tetravalent tin. In one embodiment organotin compounds that are dialkyltin salts of carboxylic acids, can include the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations thereof.

In one embodiment, the catalyst can be an organotin catalyst selected from the group consisting of stannous octoate, dibutyltin dilaurate, dibutyltin diacetate, stannous oleate and combinations thereof. In another embodiment, the catalyst can be an organoamine catalyst, for example, tertiary amine such as trimethylamine, triethylamine, triethylenediamine, bis(2,2′-dimethylamino)ethyl ether, N-ethylmorpholine, diethylenetriamine, 1,8-Diazabicyclo[5.4.0]undec-7-ene and combinations thereof.

A blowing agent can be employed in the preparation of the polyurethane of the invention. These agents include, but are not limited to hydrocarbon blowing agents, such as, linear or branched alkane hydrocarbons, e.g., butane, isobutane, 2,3-dimethylbutane, n- and isopentane and technical-grade pentane mixtures, n- and isohexanes, and n- and isoheptane. Other blowing agents can be used in combination with the one or more hydrocarbon blowing agents; these may be divided into the chemically active blowing agents which chemically react with the isocyanate or with other formulation ingredients to release a gas for foaming, and the physically active blowing agents which are gaseous at the exotherm foaming temperatures or less without the necessity for chemically reacting with the foam ingredients to provide a blowing gas. Included within the meaning of physically active blowing agents are those gases which are thermally unstable and decompose at elevated temperatures. Examples of chemically active blowing agents are preferably those which react with the isocyanate to liberate a gas, such as CO₂. Suitable chemically active blowing agents include, but are not limited to, water, mono- and polycarboxylic acids having a molecular weight of from 46 to 300, salts of these acids, and tertiary alcohols.

Alternatively, water and/or CO₂ may be used as the sole blowing agent(s) or as co-blowing agents with a hydrocarbon blowing agent. Water reacts with the organic isocyanate to liberate CO₂ gas which is the actual blowing agent. However, since water consumes isocyanate groups, an equivalent molar excess of isocyanate should be provided to make up for the consumed isocyanates.

Moreover, there can be employed optional components other than those mentioned above, for instance, other auxiliaries such as cross-linking agents, stabilizers, surfactants, pigments, flame retardants, chain-extending agents, and fillers within a range which would not hinder the object of the present invention.

A surface-active agent is generally necessary for production of high grade polyurethane foam according to the present invention, since in the absence of same, the foams collapse or contain very large uneven cells. Numerous surface-active agents have been found satisfactory. Nonionic surface active agents are preferred. Of these, the nonionic surface-active agents such as the well-known silicones have been found particularly desirable. Other surface-active agents which are operative, although not preferred, include polyethylene glycol ethers of long chain alcohols, tertiary amine or alkanolamine salts of long chain alkyl acid sulfate esters, alkyl sulfonic esters, and alkyl arylsulfonic acids.

Methods for producing polyurethane foam from the polyurethane foam-forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used.

The following examples are offered to illustrate the general nature of the invention. Those skilled in the art will appreciate that they are not limiting to the scope and spirit of the invention and various and obvious modifications will occur to those skilled in the art. All parts are by weight unless otherwise stated.

### EXAMPLES

Flame-retarded polyurethane foam Examples 1-7 and Comparative Examples 1-7 were hand mixed laboratory pours made in a box (free rise). The components of the formulation are identified in Table 1 below, shown as parts by weight in relation to 100 parts by weight of the polyol.

TABLE 1

| ADDITIVE | ADDITION LEVEL |
|---|---|
| Vorinol 3136 (polyether polyol with | 100 |
| an OH number of 54, available from | |
| Dow) | |
| FR (Phosphate available from | 5-25 |
| Supresta, LLC) | |
| Melamine (Melamine 003 Grade | 5-25 |
| available from DSM) | |
| H₂O | 3.55 |
| D33LV/A-1 = 3/1 ratio (Dabco BLV | 0.23 |
| catalyst available from Air Products) | |
| Silicone L-620 (Niax Silicone L-620 | 0.80 |
| available from General Electric | |
| Advanced Materials) | |
| Stannous Octoate T-10 (Dabco T-10 | 0.55 |
| available from Air Products) | |
| TDI (Mondur TD-80 Grade A | 47.33 |
| available from Bayer Material | |
| Science) | |
| TDI Index | 110 |

The Examples and Comparative Examples given below were subjected to either the fully certified British Standard 5852 (BS 5852) test criteria or a non-certified reduced-scale version of the British Standard 5852 (BS 5852) Supresta LLC developed for the specific purpose of screening new product candidates using less foam than required by the normal BS 5852. The British Standard 5852 test measures the combustion properties of a combination of both fabric and filling materials. The standard sample in the evaluation is made up of two standard polyurethane foam cushions in a chair configuration. The certified BS 5852 uses foam samples measuring 18″×18″×3″ for back and 12″×18″×3″ for bottom, and a Crib # 5 ignition source. The non-certified reduced-scale version of the British Standard 5852 (BS 5852) Supresta LLC developed for screening new samples uses foam samples measuring 11″×11″×3″ for back and 11″×8″×3″ for bottom, a Crib # 4 ignition source, and no fabric cover.

Examples 1-3 and Comparative Examples 1-2 were tested using a non-certified reduced-scale version of the British Standard 5852 (BS 5852) developed by Supresta, LLC. The cured polyurethane foam of Examples 1-3 and Comparative Examples 1 and 2, included in various amounts (as presented in Table 2) the following flame-retardant materials: neopentyl phenyl phosphate (NPP); and melamine (obtained from the DSM Co. 99% having a particle size of 40 microns).

The neopentyl phenyl phosphate (NPP) used in the Examples was prepared as follows: 2109.8 grams (10 mol) of monophenyl chlorophosphate (MPCP) was placed in a reactor with an agitator, a thermometer, a nitrogen inlet, and a condenser connected to a scubber as a nitrogen outlet. The scrubber was also connected to a vacuum system (water-pump). The reactor was cooled to 10° C. and 1041.5 grams (10 mol) of neopentyl glycol (NPG) was added. Cooling was discontinued and the reactor opened to vacuum. The temperature of the reaction gradually went up from 10° C. to 24° C. within 1 hour. The solid NPG gradually dissolved in MPCP with stirring within that hour period. Reactor temperature rose to 50-60° C. after NPG totally dissolved, and then the system solidified again due to the formation of the NPP product. One liter of toluene was added to the reactor and heated to 100° C. The system became liquid thereby completing the reaction. (Alternatively, the reaction can be driven to completion without adding any solvent (i.e., toluene) to the reactor. In this method, the reactor is heated to 135° C. and the system becomes liquid thereby completing the reaction) The preparation of NPP continued by the addition of 200 ml of 10% aqueous NaOH to the liquid product. After stirring 1 minute, the product was poured into a metal pan at high temperature in its liquid state. After solidifying, the solid product was ground with a pestle. The solid particles were filtered to remove water. The pH was checked (typically >8). The solid was put back in the pan and 200 ml of water was added. The product was ground again, and then filtered again to remove water. Product washing continued until its pH was in the range of 7-8. The NPP was dried at 50° C. under vacuum (yield: approximately 95%).

TABLE 2

| | FR | | | Weight | Weight |
|---|---|---|---|---|---|
| | Loading | Airflow | Density | Loss | Loss |
| Examples | (pph) | ft³/min | lb/ft³ | (grams) | (%) |
| Comparative | 25 | 2.6 | 1.8 | 115 | 36 |
| Ex. 1 NPP | | | | | |
| Ex. 1 | 15/10 | 4.5 | 1.8 | 84.5 | 28.6 |
| NPP/Melamine | | | | | |
| Ex. 2 | 10/15 | 2.7 | 1.8 | 51.7 | 16.6 |
| NPP/Melamine | | | | | |
| Ex. 3 | 5/20 | 3.0 | 1.8 | 124 | 41.6 |
| NPP/Melamine | | | | | |
| Comparative | 25 | 2.0 | 1.8 | EM* | EM* |
| Ex. 2 | | | | | |
| Melamine | | | | | |

*Extinguished manually

Comparative Examples 1 and 2 clearly show the use of 25 parts of either the NPP phosphate or melamine by themselves yield poor flammability results and high weight loss numbers. However, using a combination system employing both NPP and melamine at reasonable levels, e.g., Example 1 and 2, yield much more favorable results. Examples 1 and 2 clearly show a synergistic relationship between NPP and melamine.

Examples 4-7 and Comparative Examples 3-7 were tested pursuant to the fully certified British Standard 5852 (BS 5852) test criteria. The cured polyurethane foam of Examples 4-7 and Comparative Examples 3-7, included in various amounts (as presented in Table 3) the following flame-retardant materials: tris (chloropropyl) phosphate (TCPP); tris (dichloroisopropyl) phosphate (TDCP); 2,2-bis(chloromethyl) trimethylene bis(bis(2-chloroethyl) phosphate (V6); neopentyl phenyl phosphate (NPP); and melamine (obtained from the DSM Co. 99% having a particle size of 40 microns). The results are displayed in Table 3.

TABLE 3

| | Load- | Air- | Den- | | Weight Loss & |
|---|---|---|---|---|---|
| | ing | flow | sity | BS-5852 | Time |
| Comparative Ex. 3 | 13/20 | 2.2 | 2.1 | pass | 56.3 grams |
| TCPP/Melamine | | | | | 9 min 10 sec |
| Comparative Ex. 4 | 15/20 | 2.5 | 2.0 | pass | 44.4 grams |
| TCPP/Melamine | | | | | 8 min 10 sec |
| Comparative Ex. 5 | 18/20 | 2.3 | 2.0 | pass | 29.1 grams |
| TCPP/Melamine | | | | | 5 min 26 sec |
| Comparative Ex. 6 | 18/20 | 2.4 | 2.1 | pass | 58.8 grams |
| TDCP/Melamine | | | | | 5 min 45 sec |
| Comparative Ex. 7 | 18/20 | 2.3 | 2.1 | fail | 97.7 grams |
| V-6/Melamine | | | | | 9 min 20 sec |
| Example 4 | 11/20 | 2.0 | 2.3 | pass | 36.2 grams |
| NPP/Melamine | | | | | 3 min 15 sec |
| Example 5 | 13/20 | 2.1 | 2.3 | pass | 35.1 grams |
| NPP/Melamine | | | | | 3 min 20 sec |
| Example 6 | 15/20 | 2.2 | 2.1 | pass | 27.3 grams |
| NPP/Melamine | | | | | 4 min 0 sec |
| Example 7 | 18/20 | 2.2 | 2.1 | pass | 38.5 grams |
| NPP/Melamine | | | | | 3 min 40 sec |

As indicated from the data displayed in Table 3, all of the non-halogen containing flame-retardant mixtures of the invention (i.e., NPP/melamine blends) exceeded the British Standard 5852 (BS 5852) test criteria up to and including the lowest use level measured (i.e., use level of 11 parts NPP and 20 parts melamine).

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A flame-retarded polyurethane foam comprising:
a) a polyurethane foam; and
b) an effective flame retarding amount of a flame-retardant mixture comprising:
i) at least one non halogen-containing cyclic phosphate ester having the general formula: 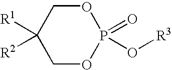
wherein R¹ and R², are the same or different, 1 to 6 carbon atom(s) straight-chain or branched alkyl groups, which may or may not contain heteroatom substituents, and R³ is phenyl or substituted phenyl containing from 6 to 12 carbon atoms, which may or may not contain heteroatom substituents; and
ii) at least one non halogen-containing melamine compound.

2. The flame-retarded polyurethane foam of claim 1 wherein R¹ and R² are independently selected from the group consisting of methyl, ethyl, n-propyl, n-butyl, n-pentyl, n-hexyl, iso-propyl, iso-butyl, sec-butyl, tert-butyl, iso-pentyl, tert-pentyl, neo-pentyl, and iso-hexyl, which may or may not contain heteroatom substituents.

3. The flame-retarded polyurethane foam of claim 1 wherein R³ is phenyl or methyl substituted phenyl.

4. The flame-retarded polyurethane foam of claim 1 wherein the phosphate ester is cyclic neopentyl phenyl phosphate.

5. The flame-retarded polyurethane foam of claim 1 wherein the melamine compound has the general formula: 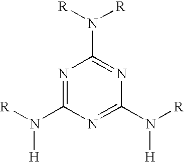
wherein, each R is independently selected from the group consisting of hydrogen, C₁₋₆ alkyl group, C₅₋₆ cycloalkyl group, C₆₋₁₂ aryl group, and C₇₋₁₂ aralkyl group.

6. The flame-retarded polyurethane foam of claim 5 wherein the melamine compound is at least one selected from the group consisting of melamine, melamine cyanurate, melamine pyrophosphate, N-methylmelamine, N-cyclohexylmelamine, N-phenylmelamine, N,N-dimethylmelamine, N,N-diethylmelamine, N,N-dipropylmelamine, N,N′-dimethylmelamine, and N,N′,N″-trimethylmelamine.

7. The flame-retarded polyurethane foam of claim 6 wherein the melamine compound is melamine.

8. The flame-retarded polyurethane foam of claim 1 wherein the cyclic phosphate ester is neopentyl phenyl phosphate and the melamine compound is melamine.

9. The flame-retarded polyurethane foam of claim 1 wherein the cyclic phosphate ester ranges in amount from about 1 to about 20 weight percent of the total weight of the polyurethane foam.

10. The flame-retarded polyurethane foam of claim 1 wherein the cyclic phosphate ester ranges in amount from about 3 to about 18 weight percent of the total weight of the polyurethane foam.

11. The flame-retarded polyurethane foam of claim 1 wherein the cyclic phosphate ester ranges in amount from about 5 to about 15 weight percent of the total weight of the polyurethane foam.

12. The flame-retarded polyurethane foam of claim 1 wherein the melamine compound ranges in amount from about 1 to about 20 weight percent of the total weight of the polyurethane foam.

13. The flame-retarded polyurethane foam of claim 1 wherein the melamine compound ranges in amount from about 2 to about 18 weight percent of the total weight of the polyurethane foam.

14. The flame-retarded polyurethane foam of claim 1 wherein the melamine compound ranges in amount from about 2 to about 15 weight percent weight of the total weight of the polyurethane foam.

15. The flame-retarded polyurethane foam of claim 1 wherein the flame-retardant mixture has a ratio of cyclic phosphate ester to melamine that ranges from about 1:10 to about 10:1.

16. The flame-retarded polyurethane foam of claim 1 wherein the flame-retardant mixture has a ratio of cyclic phosphate ester to melamine that ranges from about 1:5 to about 5:1.

17. The flame-retarded polyurethane foam of claim 1 wherein the flame-retardant mixture has a ratio of cyclic phosphate ester to melamine that ranges from about 1:3 to about 3:1.

18. The flame-retarded polyurethane foam of claim 1 wherein the polyurethane foam possesses a density of below about 50 kg/m³ (3.12 pounds per ft³).

19. The flame-retarded polyurethane foam of claim 1 wherein the polyurethane foam possesses a density of above about 12 kg/m³ (0.75 pounds per ft³).

20. The flame-retarded polyurethane foam of claim 1 wherein the polyurethane foam possesses an index of organic isocyanate and polyol components is at least about 90.

21. The flame-retarded polyurethane foam of claim 1 further comprising at least one additional component selected from the group consisting of cross-linking agent, stabilizer, surfactant, pigment, flame retardant, chain-extending agent, and filler.
